(19) United States
(12) Patent Application Publication
(10) Pub. No.: US 2005/0137729 A1
(43) Pub. Date: Jun. 23, 2005

(54) Time-scale modification stereo audio signals

(76) Inventors: Atsuhiro Sakurai, Tsukuba-shi (JP); Yoshihide Iwata, Tsukuba (JP)

Correspondence Address: TEXAS INSTRUMENTS INCORPORATED, P O BOX 655474, M/S 3999, DALLAS, TX, 75265, US

(21) Appl. No.: 10/739,677

(22) Filed: Dec. 18, 2003

(51) Int. Cl. G06F 17/00; H04R 5/00

(52) U.S. Cl. 700/94; 381/1

(57) ABSTRACT

An efficient time scale modification (TSM) scheme for stereo signals is proposed where the overlap point is calculated just once per stereo frame based on a downmixed signal. The proposed scheme results in significantly lower computational cost compared with conventional methods: about 1.2 to 1.3 times the amount of computation required by monoaural signals, against 2.0 times the amount of computation required by channel-independent methods. Listening tests indicate that the quality achieved is higher than conventional channel-independent approaches due to the preservation of the spatial localization of the sound.

### TECHNICAL FIELD OF THE INVENTION

The technical field of this invention is time scale modification of audio signals.

### BACKGROUND OF THE INVENTION

Time-scale modification (TSM) is an emerging topic in audio digital signal processing due to the advance of low-cost, high-speed hardware that enables real-time processing by portable devices. Possible applications include intelligible sound in fast-forward play, real-time music manipulation, foreign language training, etc. Most time scale modification algorithms can be classified as either frequency-domain time scale modification or time-domain time scale modification. Frequency-domain time scale modification provides higher quality for polyphonic sounds, while time-domain time scale modification is more suitable for narrow-band signals such as voice. Time-domain time scale modification is the natural choice in resource-limited applications due to its lower computational cost.

The basic operation of time domain time-scale modification is successively overlapping and adding audio frames, where time scaling is achieved by changing the spacing between them. It is known in the art to calculate the exact overlap point based on a measure of similarity between the signals to be overlapped. This measure of similarity is generally based on cross-correlation.

Most time-domain time-scale modification algorithms are derived from the synchronous overlap-and-add method (SOLA). The synchronous overlap-and-add algorithm and its variations are based on successive overlap and addition of audio frames. For the overlap, the overlap point is adjusted by computing a measure of signal similarity between the overlapping regions for each possible overlap position, which is limited by a minimum and maximum overlap points. The position of maximum similarity is selected. The signal similarity measure can be represented as a full cross-correlation function or simplified versions. This similarity calculation represents about 80% or more of the total computation required by the algorithm.

Special care is necessary when the synchronous overlap-and-add method is applied to stereo signals. Conventional methods process each channel separately. This independent processing of channels poses the following problems. The resulting computational cost is twice the corresponding amount for monoaural signals. Separate processing introduces a spatial localization problem. The synchronous overlap-and-add algorithm is based on fine adjustment of the overlap position based on a measure of signal similarity, generally calculated by means of a cross-correlation function. If the overlap position is calculated independently for each channel, fluctuations of phase differences between left and right channels will occur. These fluctuations produce annoying disruptions of spatial localization.

### SUMMARY OF THE INVENTION

This invention is a simple method that eliminates the problems of separate computation of the overlap point for stereo channels. This invention calculates a unique overlap point for both channels based on a downmixed signal, which is a simple average between left and right channels.

The invention results in significantly lower computational cost than separate computation of overlap for the two channels. The invention requires about 1.2 to 1.3 times the computational cost required by treating the separate stereo channels as monoaural signals. This invention produces higher quality than conventional channel-independent methods.

### BRIEF DESCRIPTION OF THE DRAWINGS

These and other aspects of this invention are illustrated in the drawings, in which:

FIG. 1 is a block diagram of a digital audio system to which this invention is applicable;

FIG. 2 is a flow chart illustrating the data processing operations involved in time-scale modification employing the digital audio system of FIG. 1;

FIG. 3a illustrates the analysis step in the overlap and add method of time scale modification according to the prior art;

FIG. 3b illustrates the synthesis step in the overlap and add method of time-scale modification according to the prior art;

FIG. 4a illustrates the analysis step in synchronous overlap and add method of time scale modification according to the prior art;

FIG. 4b illustrates the synthesis step in the synchronous overlap and add method of time-scale modification according to the prior art;

FIG. 5 illustrates a block diagram of the processes involved in application of the synchronous overlap and add method of time-scale modification to stereo signals according to the prior art; and

FIG. 6 illustrates a block diagram of the processes involved in application of the synchronous overlap and add method of time-scale modification to stereo signals according to this invention.

### DETAILED DESCRIPTION OF PREFERRED EMBODIMENTS

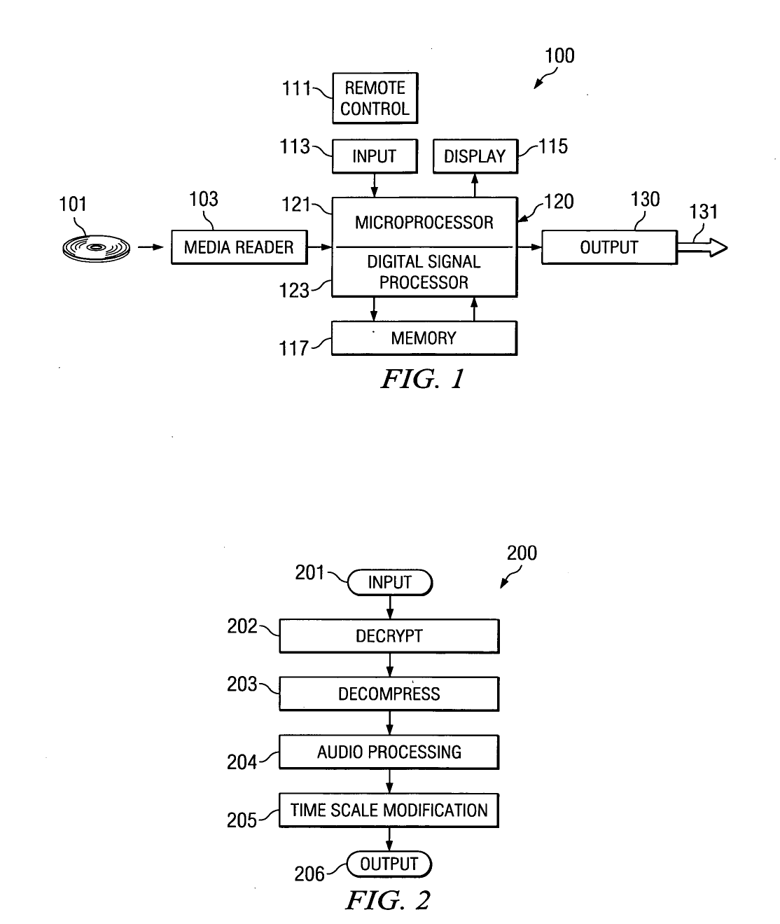

FIG. 1 is a block diagram illustrating a system to which this invention is applicable. The preferred embodiment is a DVD player or DVD player/recorder in which the time scale modification of this invention is employed with fast forward or slow motion video to provide audio synchronized with the video in these modes.

System 100 received digital audio data on media 101 via media reader 103. In the preferred embodiment media 101 is a DVD optical disk and media reader 103 is the corresponding disk reader. It is feasible to apply this technique to other media and corresponding reader such as audio CDs, removable magnetic disks (i.e. floppy disk), memory cards or similar devices. Media reader 103 delivers digital data corresponding to the desired audio to processor 120.

Processor 120 performs data processing operations required of system 100 including the time scale modification of this invention. Processor 120 may include two different processors, microprocessor 121 and digital signal processor 123. Microprocessor 121 is preferably employed for control functions such as data movement, responding to user input and generating user output. Digital signal processor 123 is preferably employed in data filtering and manipulation functions such as the time scale modification of this invention. A Texas Instruments digital signal processor from the TMS320C5000 family is suitable for this invention.

Processor 120 is connected to several peripheral devices. Processor 120 receives user inputs via input device 113. Input device 113 can be a keypad device, a set of push buttons or a receiver for input signals from remote control 111. Input device 113 receives user inputs which control the operation of system 100. Processor 120 produces outputs via display 115. Display 115 may be a set of LCD (liquid crystal display) or LED (light emitting diode) indicators or an LCD display screen. Display 115 provides user feedback regarding the current operating condition of system 100 and may also be used to produce prompts for operator inputs. As an alternative for the case where system 100 is a DVD player or player/recorder connectable to a video display, system 100 may generate a display output using the attached video display. Memory 117 preferably stores programs for control of microprocessor 121 and digital signal processor 123, constants needed during operation and intermediate data being manipulated. Memory 117 can take many forms such as read only memory, volatile read/write memory, nonvolatile read/write memory or magnetic memory such as fixed or removable disks. Output 130 produces an output 131 of system 100. In the case of a DVD player or player/recorder, this output would be in the form of an audio/video signal such as a composite video signal, separate audio signals and video component signals and the like.

FIG. 2 is a flow chart illustrating process 200 including the major processing functions of system 100. Flow chart 200 begins with data input at input block 201. Data processing begins with an optional decryption function (block 202) to decode encrypted data delivered from media 101. Data encryption would typically be used for control of copying for theatrical movies delivered on DVD, for example. System 100 in conjunction with the data on media 101 determines if this is an authorized use and permits decryption if the use is authorized.

The next step is optional decompression (block 203). Data is often delivered in a compressed format to save memory space and transmit bandwidth. There are several motion picture data compression techniques proposed by the Motion Picture Experts Group (MPEG). These video compression standards typically include audio compression standards such as MPEG Layer 3 commonly known as MP3. There are other audio compression standards. The result of decompression for the purposes of this invention is a sampled data signal corresponding to the desired audio. Audio CDs typically directly store the sampled audio data and thus require no decompression.

The next step is audio processing (block 204). System 100 will typically include audio data processing other than the time scale modification of this invention. This might include band equalization filtering, conversion between the various surround sound formats and the like. This other audio processing is not relevant to this invention and will not be discussed further.

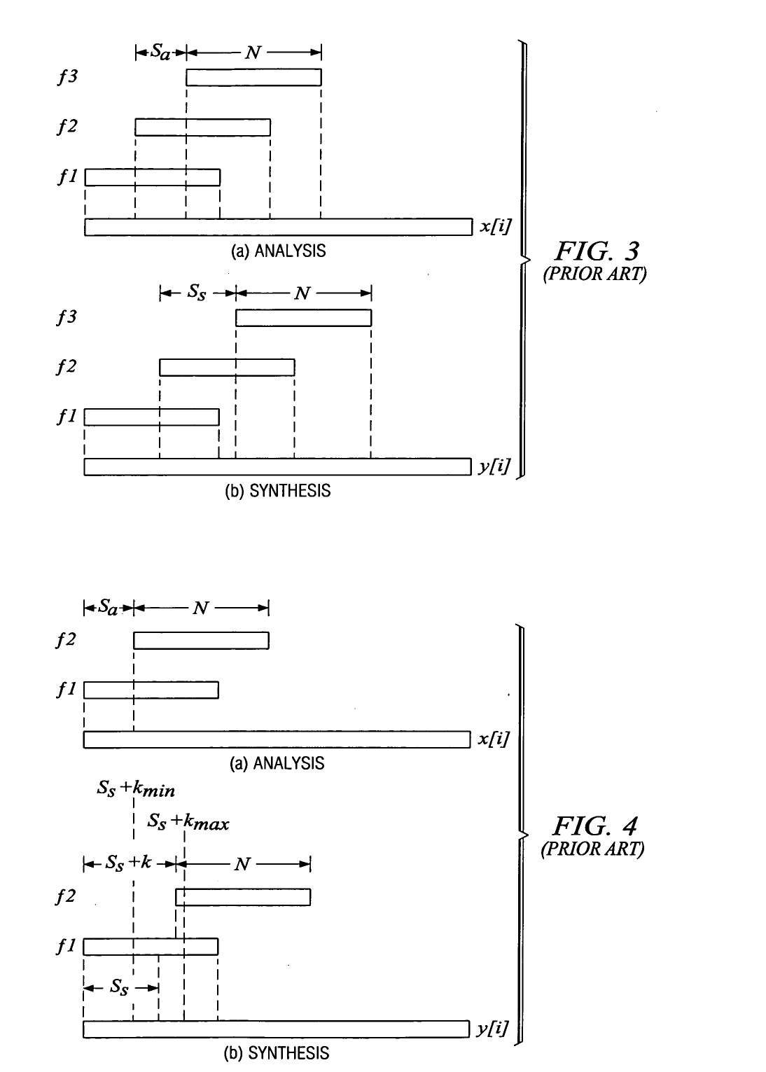

The next step is time scale modification (block 205). This time scale modification is the subject of this invention and various techniques of the prior art and of this invention will be described below in conjunction with FIGS. 3 to 6. Flow chart 200 ends with data output (block 206).

FIG. 3 illustrates this process. In FIG. 3(a), x(i) is the analysis signals represented as a sequence with index i. Similarly, FIG. 3(b) illustrates synthesis signal y(i) having a sequence index i. The quantity N is the frame size. Sₐ is the analysis frame interval between consecutive frames fⱼ (where j=1, 2 . . . ). Sₛ is the similar synthesis frame interval. The relationship between the analysis frame interval Sₐ and the synthesis frame interval Sₛ sets the time scale modification. The overlap-and-add time scale modification algorithm is simple and provides acceptable results for small time-scale factors. In general this method yields poor quality compared to other methods described below.

The synchronous overlap-and-add time scale modification algorithm is an improvement over the previous overlap-and-add approach. Instead of using a fixed overlap interval for synthesis, the overlap point is adjusted by computing the normalized cross-correlation between the overlapping regions for each possible overlap position within minimum and maximum deviation values. This normalized cross-correlation serves as a measure of the similarity of the overlapping regions. The overlap position of maximum similarity or maximum cross-correlation is selected. The cross-correlation is calculated using the following formula, where Lₖ is the length of the overlapping window:

$$R [ k ] = \frac{{\sum }_{i = 0}^{{L}_{k} - 1} y [ m {S}_{s} + k + i ] x [ m {S}_{a} + i ]}{{[ {\sum }_{i = 0}^{{L}_{k} - 1} {y}^{2} [ m {S}_{s} + k + i ] {\sum }_{i = 0}^{{L}_{k} - 1} {x}^{2} [ m {S}_{a} + i ] ]}^{1 / 2}} \qquad ( 1 )$$

FIG. 4 illustrates the synchronous overlap-and-add time scale modification algorithm. The same variables are used in FIG. 4(a) for analysis as FIG. 3(a) and used in FIG. 4(b) for synthesis as in 3(b). In FIG. 4, k is the deviation of the overlap position, with k limited to the range between kₘᵢₙ and kₘₐₓ. Note that k=0 is equivalent to the overlap-and-add time scale modification algorithm illustrated in FIGS. 3(a) and 3(b). The synchronous overlap-and-add time scale modification algorithm requires a large amount of computation to calculate the normalized cross-correlation used in equation 1. The similarity computation can be reduced using a more efficient normalized cross-correlation formula or another measure of signal similarity instead of equation 1. Even such a reduced computation will still be the most computation-expensive part of the algorithm. The following discussion applies to whatever normalized cross-correlation formula or measure of signal similarity is used. This computation enables better phase matching for each overlapping frame, thus improving the resulting sound quality.

FIG. 5 illustrates the processes of the prior art for stereo. Left channel input Lᵢₙ supplies cross-correlation computation 510. Cross-correlation computation 510 determines the current left channel overlap deviation constant kₗ. Cross-correlation computation 510 employs any of the similarity measures of the prior art to determine left channel overlap deviation constant kₗ. Left channel overlap deviation constant kₗ and the left channel input Lᵢₙ supply overlap/add computation 515. Overlap/add computation 515 re-synthesizes the audio signal producing the left channel output Lₒᵤₜ with the overlap Sₛ+kₗ selected to produce the desired time-scale modification as modified by the current left channel overlap deviation constant kₗ. In a similar fashion, cross-correlation computation 520 receives the right channel input Rᵢₙ and computes the right channel overlap deviation constant kᵣ. Overlap/add computation 525 receives the right channel input Rᵢₙ and the right channel overlap deviation constant kᵣ and re-synthesizes the right channel producing right channel output Rₒᵤₜ with the overlap Sₛ+kᵣ selected to produce the desired time-scale modification as modified by the current right channel overlap deviation constant kᵣ.

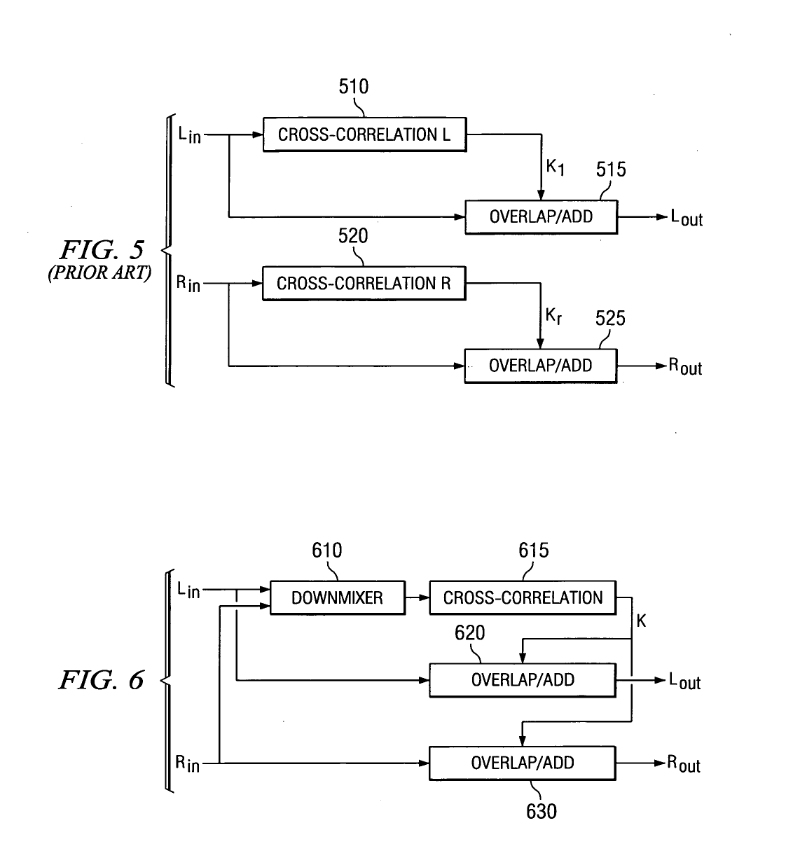

FIG. 6 illustrates the process of this invention. Downmixer 610 mixes left channel input Lᵢₙ and right channel input Rᵢₙ to produce a monoaural signal. This downmixing could be a simple average of the left channel input Lᵢₙ and the right channel input Rᵢₙ. Cross-correlation calculation 615 uses this monoaural signal to determine a unique overlap deviation constant k for both channels. The overlap deviation constant k and the left channel input Lᵢₙ supply overlap/add computation 620. Overlap/add computation 620 re-synthesizes the audic signal producing the left channel output Lₒᵤₜ with the overlap Sₛ+k selected to produce the desired time-scale modification as modified by the current overlap deviation constant k. The overlap deviation constant k and the right channel input Rᵢₙ supply overlap/add computation 630. Overlap/add computation 630 re-synthesizes the audio signal producing the right channel output Rₒᵤₜ with the overlap Sₛ+k selected to produce the desired time-scale modification as modified by the current overlap deviation constant k.

The computational cost problem of the prior art is solved by calculating one overlap position for the two channels. This overlap position calculation, previously described in conjunction with Equation 1, is usually about 80% of the total computational cost. Downmixer 610 requires considerably less computation than the cross-correlation, so the computational cost of the invention is just 1.2 to 1.3 times the corresponding cost for monoaural signals. The prior two-channel method illustrated in FIG. 5 requires about 2 times that of the monoaural case.

The spatial localization disruption problem is solved by applying a unique overlap position to both channels. This produces no difference in phase between the two channels.

Listening tests compared the inventive method with three other methods. Method 1 was the conventional channel-independent approach, such as illustrated in FIG. 5. Method 2 computed the overlap point based on only the left channel and applied this overlap to both channels. Method 3 calculated overlap points for the two channels independently and applied to both channels the overlap associated with the maximum cross-correlation. The quality achieved by the invention was equivalent to the third method despite its lower computational cost. The quality of this invention was consistently higher than the first and second methods.

1. A method of time-scale modification of a stereo digital audio signal having separate left input channel and right input channel comprising the steps of:
analyzing the left input channel in a set of first equally spaced, overlapping time windows having a first overlap amount Sₐ;
analyzing the right input channel in a set of first equally spaced, overlapping time windows having a first overlap amount Sₐ;
selecting a base overlap Sₛ for output synthesis corresponding to a desired time scale modification;
downmixing the left input channel and right input channel into a single audio signal;
calculating a measure of similarity between overlapping frames of the single audio signal for a range of overlaps between Sₛ+kₘᵢₙ to Sₛ+kₘₐₓ of the single audio signal, where kₘᵢₙ is a minimum overlap deviation and kₘₐₓ is a maximum overlap deviation;
determining an overlap deviation k yielding the largest measure of similarity;
synthesizing a left channel output signal in a set of second equally spaced, overlapping time windows of the left input channel having a second overlap amount equal to Sₛ+k; and
synthesizing a right channel output signal in a set of second equally spaced, overlapping time windows of the right input channel having a second overlap amount equal to Sₛ+k.

2. The method of claim 1, wherein:
said step of downmixing the separate left input channel and right input channel into a single audio signal averages the left input channel and the right input channel.

3. The method of claim 1, wherein:
said step of calculating a measure of similarity between overlapping frames of the single audio signal calculates R[k] as follows:
$$R [ k ] = \frac{{\sum }_{i = 0}^{{L}_{k} - 1} y [ m {S}_{s} + k + i ] x [ m {S}_{a} + i ]}{{[ {\sum }_{i = 0}^{{L}_{k} - 1} {y}^{2} [ m {S}_{s} + k + i ] {\sum }_{i = 0}^{{L}_{k} - 1} {x}^{2} [ m {S}_{a} + i ] ]}^{1 / 2}}$$
where: Lₖ is the length of the overlapping window between the original signal x and the time displaced signal y; i is an index variable; and k is the overlap deviation and is limited to the range kₘᵢₙ<k <kₘₐₓ.

4. A digital stereo audio apparatus comprising:
a source of a left digital audio signal and a right digital audio signal;
a digital signal processor connected to said source of a left digital audio signal and right digital audio signal programmed to perform time scale modification on the left digital audio signal and the right digital audio signal by
analyzing the left digital audio signal in a set of first equally spaced, overlapping time windows having a first overlap amount Sₐ;
analyzing the right digital audio signal in a set of first equally spaced, overlapping time windows having a first overlap amount Sₐ;
selecting a base overlap Sₛ for output synthesis corresponding to a desired time scale modification;
downmixing the left digital audio signal and right digital audio signal into a single digital audio signal;
calculating a measure of similarity between overlapping frames of the single digital audio signal for a range of overlaps between Sₛ+kₘᵢₙ to Sₛ+kₘₐₓ of the single audio digital signal, where kₘᵢₙ is a minimum overlap deviation and kₘₐₓ is a maximum overlap deviation;
determining an overlap deviation k yielding the largest measure of similarity;
synthesizing a left channel output signal in a set of second equally spaced, overlapping time windows of the left digital audio signal having a second overlap amount equal to Sₛ+k; and
synthesizing a right channel output signal in a set of second equally spaced, overlapping time windows of the right digital audio signal having a second overlap amount equal to Sₛ+k;
an output device connected to the digital signal processor for outputting the time scale modified left channel output signal and the time scale modified right channel output signal.

5. The digital stereo audio apparatus of claim 4, wherein:
said digital signal processor is programmed to downmix the separate left digital audio signal and right digital audio signal into the single digital audio signal by averaging the left digital audio signal and the digital audio signal.

6. The digital stereo audio apparatus of claim 4, wherein:
said digital signal processor is programmed to calculate the measure of similarity between overlapping frames of the single digital audio signal R[k] as follows:
$$R [ k ] = \frac{{\sum }_{i = 0}^{{L}_{k} - 1} y [ m {S}_{s} + k + i ] x [ m {S}_{a} + i ]}{{[ {\sum }_{i = 0}^{{L}_{k} - 1} {y}^{2} [ m {S}_{s} + k + i ] {\sum }_{i = 0}^{{L}_{k} - 1} {x}^{2} [ m {S}_{a} + i ] ]}^{1 / 2}}$$
where: Lₖ is the length of the overlapping window between the original signal x and the time displaced signal y; i is an index variable; and k is the overlap deviation and is limited to the range kₘᵢₙ<k<kₘₐₓ.
